(19) United States
(12) Patent Application Publication
(10) Pub. No.: US 2005/0157755 A1
(43) Pub. Date: Jul. 21, 2005

(54) Method for data transmission in the hybrid network and hybrid network router

(75) Inventor: Alexander G. Kashkarov, St. Petersburg (RU)

Correspondence Address: HOUSTON ELISEEVA, 4 MILITIA DRIVE, SUITE 4, LEXINGTON, MA, 02421, US

(73) Assignee: Airgain, Inc, Carlsbad, CA (US)

(21) Appl. No.: 10/939,299

(22) Filed: Sep. 10, 2004

(30) Foreign Application Priority Data
Sep. 10, 2003 (RU) RU2003128345

(51) Int. Cl. H04J 3/24

(52) U.S. Cl. 370/473

(57) ABSTRACT

Refers to networks that are comprised of wire and wireless transceivers connected by wire lines to form a hybrid network. The method implies: transmission of a data packet by one transceivers of the network; reception of an initial fragment of the said packet by a router and storage of the said fragment in a buffer storage; transmission of the stored fragment by the router to an addressee of the network. Reception and storage of a successive fragment of the packet are performed simultaneously with transmission. Then cycles of transmission of the stored fragment and simultaneous reception of a successive fragment are repeated right up to the last fragment, whereupon the last stored fragment is transmitted by the router. The router includes: a wire communication transceiver; a wireless communication transceiver with an antenna system; a processor designed for processing data packets to transmit and receive them by radio channel and wire line; a storage to store a fragment of the data packet.

### RELATED APPLICATION

This application claims priority to Russian application serial number RU2003128345 filed on Sep. 10, 2003 which is incorporated by reference herein in its entirety.

### BACKGROUND OF THE INVENTION

The invention claimed herein relates to; (i) networks that are comprised of wire and wireless transceivers joined by wire lines to form a single hybrid network, and (ii) methods for the transmission of various kind of data used in this network. Such a network includes at least two groups of transceivers that are capable of peer-to-peer communicating at least within a group and using wire lines, for example existing electric power lines, to communicate with transceivers of the other group.

Currently wireless local area communication networks (WLAN) are finding more and more extensive use in the field of information science and videographic communication applications for the purpose of transmission and distribution of data and other information among multiple users (terminals) located inside one and the same building (for example, among personal computers, laptop computers, “electronic secretaries”, printers and other devices located in one and the same building without any restrictions on the “mobility” of these devices). Taking into consideration that the radio communication coverage and range of action of such WLANs are quite limited because of low power of the transceivers of users, the remote groups of users are usually united together to form a single network by laying special connecting wires. However, such a wiring requires extra expenses. In the last few years hybrid networks have appeared, in which the existing wire lines such as telephone lines, electric power lines, were used to unite remote WLAN into a single network. Hybrid networks are usually arranged with the employment of routers, i.e. matching units (bridges) or inter-network transition units (gateways). There are certain different methods for data transmission in such hybrid networks and devices to implement such methods [1-10].

For example, a method for data transmission in a hybrid networks is known which includes local area networks connected with the main wire network by means of routers, and ad hoc local area networks (LAN) not connected to the main network [1]. This method implies presetting of identifying parameters that determine multi-address groups of terminals for each ad hoc local area network and identification of these ad hoc LAN by using the said identifying parameters. The identifying parameters, needed to determine multi-address groups that form an ad hoc LAN, are set by transmitting an identifying test message via one of the terminals to other terminals and by waiting for an appropriate response message for a fixed time interval. Terminals send an appropriate response message or do not respond to a test message, depending on whether they belong to a given multi-address group or not.

A certain method ensures transmission of messages to the terminals that form various as hoc LAN by using one and the same group address. However, the procedure of determining a concrete ad hoc LAN takes quite a long period of time, thus leading to a delay in reception of data by terminals.

Another hybrid network is known [2] that includes a router, namely a master system for wireless communication and slave systems for data exchange with data processing terminals. The master system incorporates a local converter designed to convert data received from a wireless network and to enter them into the electric power line, a converter designed to convert data received from an electric power line and to transmit them into the wireless network, and equipment designed to transmit data via the electric power line. Each slave system incorporates a local converter designed to convert data received from the data processing terminal and to transmit them into the electric power line and equipment to transmit data via the electric power line.

In the known hybrid network, the data processing terminals transmit data into the wireless network and receive data from it via the master system only. They are incapable of providing peer-to-peer communication, which restricts the functionality of the network.

A router for the hybrid network is known [3] that incorporates a radio communication antenna with terminals, a receiver, a transmitter, a converter designed to convert data received from the terminal and enter them into the electric power line, a converter designed to convert data received from the electric power line and to transmit them into the wireless network, a control unit, a supply unit, and a connector designed for connecting to the electric power line.

This router enables one to perform data exchange between wireless terminals via the existing electric power lines. However, the entry of data to the said line is performed only after these data are received from the terminal, which slows down the process of communication.

An analog closest to the invention claimed herein in terms of the combination of essential features is the method for data transmission via the hybrid network [9] that incorporates a wire local area network connected via the bridging means—routers—with the wireless local area network. The prototype method implies transmission of data packet performed by one of transceivers of the wireless local area network, reception, recognition (identification) and storage of the data packet in the buffer storage performed by the first router, waiting for a first signal by this router during a preset time interval that confirms the reception of the data packet by the addressee of the said wireless local area network, and, in the absence of the said first signal, transmission of the second signal performed by the first router that confirms the reliable reception of the data packet and its retransmission to the transceiver-addressee of the wireless network either directly or by transmitting the data packet into the wire line. In the latter case the second router receives the data packet from the wire line, identifies the data packet and transmits it further to the transceiver-addressee of the wireless local area network.

The drawback of this method for data transmission in the hybrid network consists in an excessive long time of delivery of data packets, which is determined by a delay in retransmission of the packet because of the necessity of waiting for a possible arrival of a signal indicating on reception of the data packet directly by a transceiver-addressee.

Another hybrid network is known [10] that incorporates a multitude of wireless transceivers that form a wireless network, and multitude of wire transceivers that form a wire network, in particular, using the existing electric power lines for communication. The wireless network is connected to the wire network by at least two routers (bridges). Each router includes a wire communication transceiver, a wireless communication transceiver, a processor intended for processing data packets for the purpose of subsequent transmission and reception of them by radio communication and the wire line, a buffer storage for the said packet. At that, the first input/output of the wire communication transceiver is connected to the wire line, while its other inputs/outputs are connected to the inputs/outputs of the said processor, the first input/output of the wireless communication transceiver is connected to the antenna system, whereas its other inputs/outputs are connected to the inputs/outputs of the said processor, in its turn, connected with the said buffer storage.

Retransmission of the data packet in this hybrid network is performed only when the packet is completely received by the router and stored by its buffer storage. As a result, the time of data delivery in such a network appears to be excessively high.

A router of the hybrid network is known [10] that is comprised of a transceiver of wire network, a transceiver of wireless network equipped with an antenna system, a processor intended for processing data packets to subsequently transmit and receive them by radio communication and the wire line, with said processor incorporating a wireless medium access controller, a wire line access controller, and a buffer storage intended to save and store the data packet received.

This router starts transmission of data packet only after the packet has been completely received by the router and stored by its buffer storage. As a result, the time of deliver of the data packet proves to be excessively high.

### SUMMARY OF THE INVENTION

The task of the present invention was to develop such a method for data transmission, such a hybrid network and a router (to be incorporated in said hybrid network) that would preserve the advantages of the prototypes and ensure a decrease in time of delivery of data and other information to an addressee.

The present invention is based on the implementation of synchronous transmission of data packet fragments as they are received by the router following the reception and identification of the initial fragment of this packet. Such a synchronous fragment-by-fragment reception/transmission of the data packet, instead of reception and storage of the entire data packet and its further transmission, makes it possible to reduce a time cycle of data reception/transmission, thereby speeding up data exchange in the hybrid network.

This engineering problem is solved in such a way that in the method for data transmission in the hybrid network comprised of at least one wireless transceiver, at least one wire transceiver, and at least one router capable of providing communication with the said transceivers of the said network, including the transmission of the data packet by one of the transceivers of the said network, reception of an initial fragment of the said packet by the router, storage of the received initial fragment of the packet by the buffer storage of the router, transmission of the fragment stored by the said storage by the router to the addressee of the network, simultaneous reception of a successive fragment of the packet and its storage, repetition of the cycle—transmission of the fragment, stored by the said storage, by the router, simultaneous reception of a successive fragment and its storage by the said storage, right up to the last fragment of the packet, and transmission of the fragment of data packet, stored by the said storage, by the router to the addressee of the network.

When a fragment of the data packet is received, it can be identified and stored by the storage (in the identified form).

When performing an identification of the initial fragment of the data packet, it is also possible to determine the parameters of reception of the packet and to set the parameters of transmission of the data packet to an addressee.

The parameters of spectra of a data packet and the rate of its reception and transmission can be used as the above-mentioned parameters.

In the case of transmission of a data packet from one wireless transceiver to another wireless transceiver via a wire line and two routers, the following operations can be additionally carried out.

Reception by the second router of an initial fragment of the said packet transmitted by the first router; storage of the received initial fragment of the packet by the buffer storage of the second router; transmission of the initial fragment stored by the buffer storage by the second router to the wireless transceiver-addressee of the hybrid line, and simultaneous reception of a successive fragment of the packet from the first router and its storage by the buffer storage; repetition of the cycle of transmission by the second router of the fragment, stored by the said storage, and simultaneous reception of a successive fragment from the first router and its storage by the buffer storage, right up to the last fragment of the said packet; transmission of the last fragment of the data packet by the second router to the addressee of the said network.

A minimum time of transmission of a data packet with a high signal to noise ratio in the method claimed herein is achieved by performing retransmission of fragments of the data packet in the process of their reception with a short time delay.

The hybrid network, for which the method claimed herein is intended, incorporates at least one wireless transceiver, at least one wire transceiver, and at least one router capable of providing communication with the said transceivers of the said network. Each router includes a wire communication transceiver with a matching device for the wire line; a wireless communication transceiver with an antenna system; a processor intended to process the data packet for the purpose of synchronous reception and transmission of fragments of the said packed by radio communication and the wire line; and a buffer storage for a fragment of the said packet. At that, the first input/output of the wire communication transceiver is connected to the wire line through the matching device, whereas its other inputs/outputs are connected with the inputs/outputs of the said processor; the first input/output of the wireless communication transceiver is connected to the antenna system, whereas its other inputs/outputs are connected to the inputs/outputs of the said processor, in its turn, connected to the said buffer storage.

The hybrid network may include at least two wireless transceivers.

An electric power line may be used as a wire line in the hybrid network.

The problem formulated can be also solved with the aid of a router for the hybrid network; with said router being comprised of a wire communication transceiver with a matching device for a wire line; a wireless communication transceiver with an antenna system; a processor intended to process the data packet for the purpose of synchronous reception and transmission of fragments of the said packet by radio communication and the wire line; a buffer storage for a fragment of the said packet. At that, the first input/output of the wire communication transceiver is connected to the wire line via the matching device, whereas its other inputs/outputs are connected to the inputs/outputs of the said processor; the first input/output of the wireless communication transceiver is connected with the antenna system, whereas its other inputs/outputs are connected to the inputs/outputs of the said processor, in its turn, connected with the said buffer storage.

The processor of the router may include a device for detecting and identifying a fragment of a data packet, a unit for controlling and choosing reception/transmission mode equipped with a memory unit for the structure of the said network, a coder intended to code a transmitted fragment of the said packet, a device for choosing the spectrum of the data packet, a frequency synthesizer and a reception/transmission synthesizer for fragments of the data packet. At that, the first and the second inputs of the device for detecting and identifying a fragment of the data packet are connected with the second output of the wire communication transceiver and with the second output of the wireless communication transceiver, respectively; the first output of the device for detecting and identifying a fragment of the data packet is connected to the first input of the said storage, and its second output is connected to the first input of the unit for controlling and choosing the reception/transmission mode, whose first output is connected to the second input of the wire communication transceiver, and the second output is connected to the second input of the wireless communication transceiver; the third output is connected to the input of the device for choosing the spectrum of the data packet; the fourth output is connected to the input of the reception/transmission synthesizer; the fifth input/output is connected to the memory unit for the network structure; the sixth output is connected to the first input of the coder intended for coding a fragment of the data packet, whereas the seventh output is connected to the second input of the said buffer storage, whose output is connected to the second input of the coder of the said fragment, the first and the second outputs of which are connected to the third inputs of the wire communication transceiver and the wireless communication transceiver, respectively, whose fourth inputs are connected to the first and the second outputs of the frequency synthesizer, respectively; the synthesizer input is connected to the output of the device for choosing the spectrum of the data packet; the first and the second outputs of the reception/transmission synthesizer are connected to the fifth inputs of the wire communication transceiver and the wireless communication transceiver, respectively.

The antenna system of the router may include an antenna with a directional or controlled pattern that ensures an increase in communication range with wireless transceivers of the hybrid network or restricts the reception/transmission coverage.

The invention claimed herein is illustrated by graphical materials and drawing.

### BRIEF DESCRIPTION OF THE DRAWINGS

FIG. 1 shows schematically a hybrid network used to transmit data by the method claimed herein;

FIG. 2 and FIG. 3 show a block diagram of operations performed by the router in the process of reception and transmission of fragments of the data packet; FIG. 2 shows a part of the block diagram associated with the reception of fragments of the data packet by the router from a wireless line and transmission of them into a wire communication line; FIG. 3 shows a part of the block diagram associated with the reception of fragments of the data packet by the router from a wire line and transmission of them into a wireless communication line;

FIG. 4 shows a block diagram of the router claimed herein;

FIG. 5 shows a router claimed herein with one of the variants of implementation of a data packet processor;

FIG. 6 shows time intervals illustrating the process of reception and transmission of the data packet by the router by the method claimed herein; FIG. 6-a) shows a time interval of the reception of the input data packet; FIG. 6-b) shows a time interval of the reception and identification of fragments of the packet; FIG. 6-c) shows a time interval for determining the parameters of reception; FIG. 6-d) shows a time interval for setting the parameters of transmission; FIG. 6-e) shows a time interval for storing fragments identified; FIG. 6-f) shows a time interval for reading fragments identified; FIG. 6-g) shows a time interval for transmitting fragments; FIG. 6-h) shows a time interval for transmitting the data packet.

### DETAILED DESCRIPTION OF THE INVENTION

The hybrid network that performs data transmission by the method claimed herein includes spaced apart wireless and wire transceivers 1₁ 1₂, . . . 1ₙ and routers 2₁, 2₂, . . . 2ₘ, connected by wire line 3. Wireless transceivers 1₁ 1₂, 1₃, 1₅, . . . 1ₙ and routers 2₁, 2₂, 2₃, . . . 2ₘ can be equipped with omnidirectional antenna systems 4₁, 4₃, 4₄, 4₅, 4₆ or antenna systems 4₂, 4₇, 4₈, 4₉, . . . 4ₙ with a controlled pattern.

The existing electric power lines can be used as wire line 3 in the hybrid network.

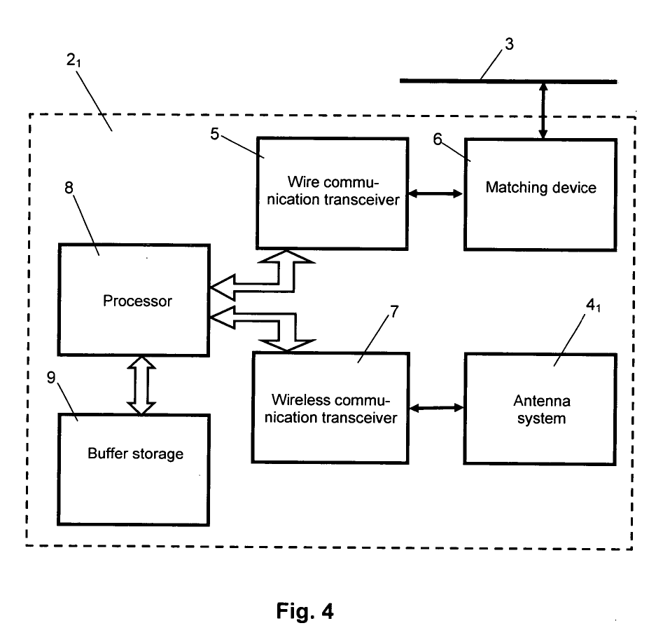

Each of routers 2₁ . . . 2ₘ for example 2₁ (see FIG. 4), that is used to implement the claimed method for data transmission in the hybrid network incorporates wire communication transceiver 5, matching device 6, wireless communication transceiver 7 with antenna system, for example 4₁, processor 8 intended to process data packets for synchronous transmission and reception of fragments of the data packet by radio communication or wire line, and buffer storage 9 intended to store a fragment of the said packet. The first input/output of wire communication transceiver 5 is intended for connecting to wire line 3 by means of matching device 6, whereas its other inputs/outputs are connected to the inputs/outputs of processor 8; the first input/output of wireless communication transceiver 7 is connected with antenna system 4₁, whereas its other inputs/outputs are connected to the inputs/outputs of processor 8, also connected with buffer storage 9.

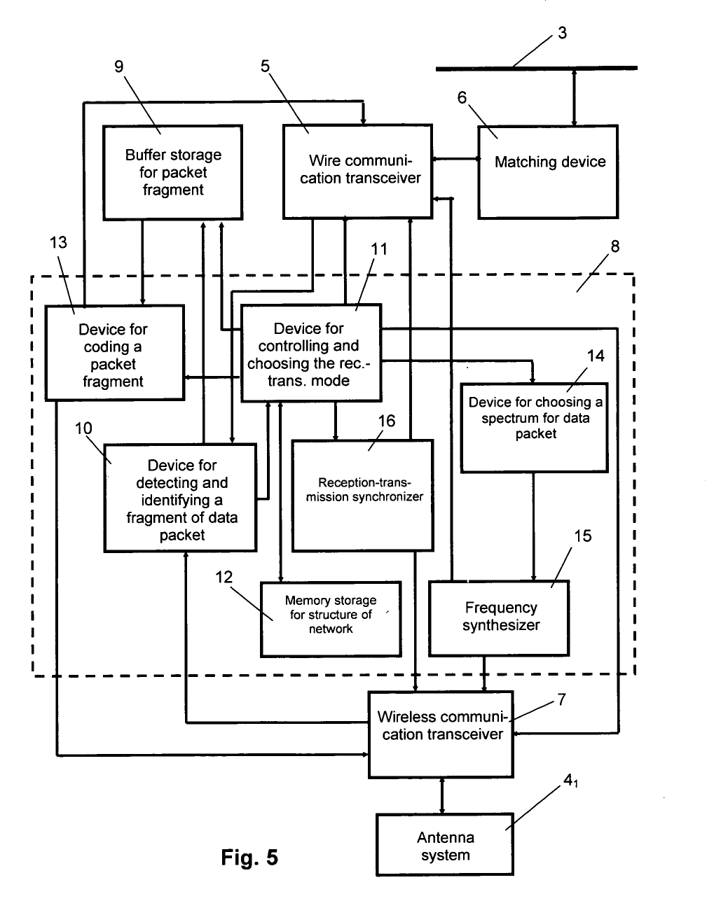

Processor 8 intended to process data packets for synchronous transmission and reception of fragments of the data packets by radio communication or wire line can be made in the following way (see FIG. 5). It includes device 10 intended for detecting and identifying a fragment of the data packet, device 11 intended to control and choose reception/transmission mode and equipped with memory unit 12 of hybrid network structure, coder 13 intended to code a fragment of the said packet being transmitted, spectrum choice device 14 of the data packet, frequency synthesizer 15 and reception/transmission synthesizer 16 of fragments of the data packet. The first and the second inputs of device 10 intended for detecting and identifying a fragment of the data packet are connected to the second output of wire communication transceiver 5 and the second output of wireless communication transceiver 7, respectively; the first output of device 10 intended for detecting and identifying a fragment of the data packet is connected to the first input of the said buffer storage 9, whereas its second output is connected to the first input of device 11 intended for controlling and choosing reception/transmission mode, whose first output is connected to the second input of wire communication transceiver 5; the second output is connected to the second input of wireless communication transceiver 7; the third output is connected to the input of spectrum choice device 14 of the data packet; the fourth output is connected to the input of reception/transmission synthesizer 16; the fifth input/output is connected to memory unit 12 of network structure; the sixth output is connected to the first input of coder 13 intended to code a fragment of the data packet, whereas the seventh output is connected to the second input of buffer storage 9, whose output is connected to the second input of coder 13 intended to code the said fragment, whose first and second outputs are connected to the third inputs of wireless communication transceiver 7 and wire communication transceiver 5, respectively; their fourth inputs are connected to the first and the second outputs of frequency synthesizer 15, respectively; the input of frequency synthesizer 15 is connected to the output of spectrum choice device 14 of the data packet; the first and the second outputs of reception/transmission synthesizer 16 are connected to the fifth inputs of wire communication transceiver 5 and wireless communication transceiver 7, respectively.

### EXAMPLE 1

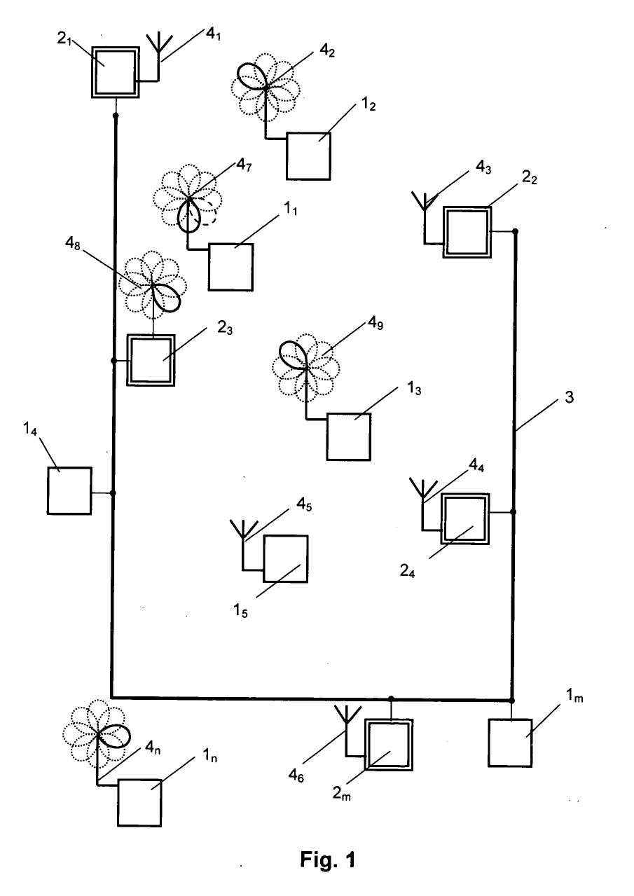

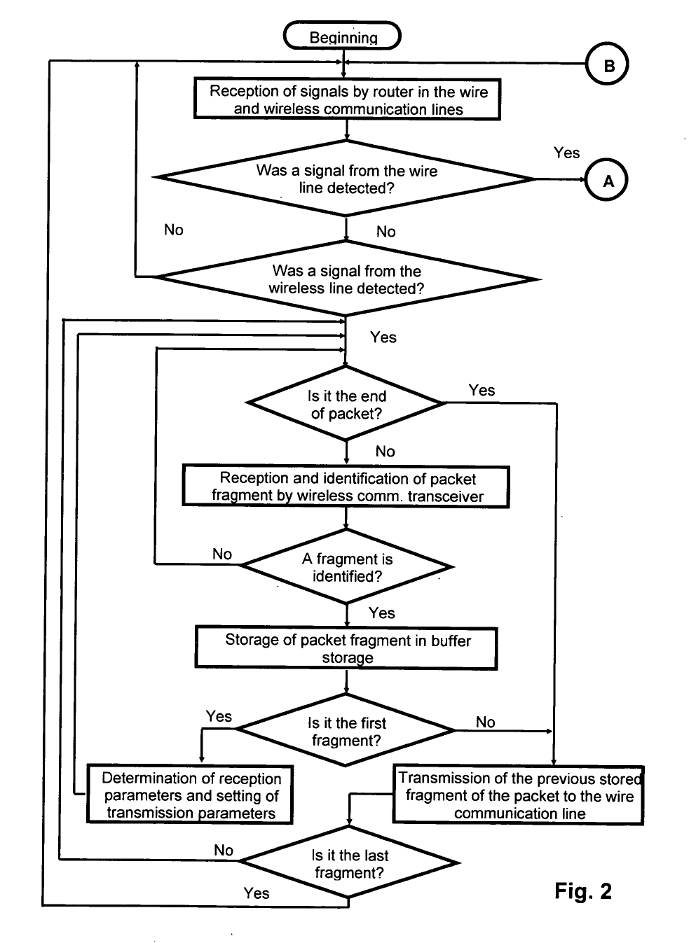

In accordance with the method claimed herein, data transmission in the hybrid network is performed in the following way. Let one of transceivers of the hybrid network (see FIG. 1), for instance, wireless transceiver 1₂, transmit a data packet to another transceiver of this network, for instance, to wire transceiver 1₄. For this purpose transceiver 1₂ transmits the data packet with the aid of antenna system 4₂ to a network router with which it has stable radio communication, for instance, router 2₁. Router 2₁ (see FIG. 4) that is ready to receive signals in wire and wireless communication lines (see FIG. 2), with the aid of its antenna system 4₁ and wireless communication transceiver 7, receives an initial fragment of the data packet transmitted by transceiver 1₂ of the data packet, and stores this fragment in buffer storage 9. Processor 8 identifies the fragment, determines the parameters of packet reception, sets the parameters of packet transmission to the addressee—wire transceiver 1₄. The initial fragment of the data packet stored by buffer storage 9 is transmitted into wire line 3 to wire transceiver 1₄ with the aid of transceiver 5 of wire network and matching device 6. Simultaneously with the transmission of the initial fragment of the packet, a successive fragment of the packet is received by wireless communication transceiver 7 and buffer storage 9 stores it. A cycle of transmission of the fragment of data packet, stored in buffer storage 9, by router 2₁ and synchronous reception of the successive fragment and the storage of it in buffer storage 9 proceeds right up to the last fragment of the data packet. When the last fragment is transmitted by transceiver 5, router 2₁ is again switched over to reception of signals in wire and wireless communication lines.

### EXAMPLE 2

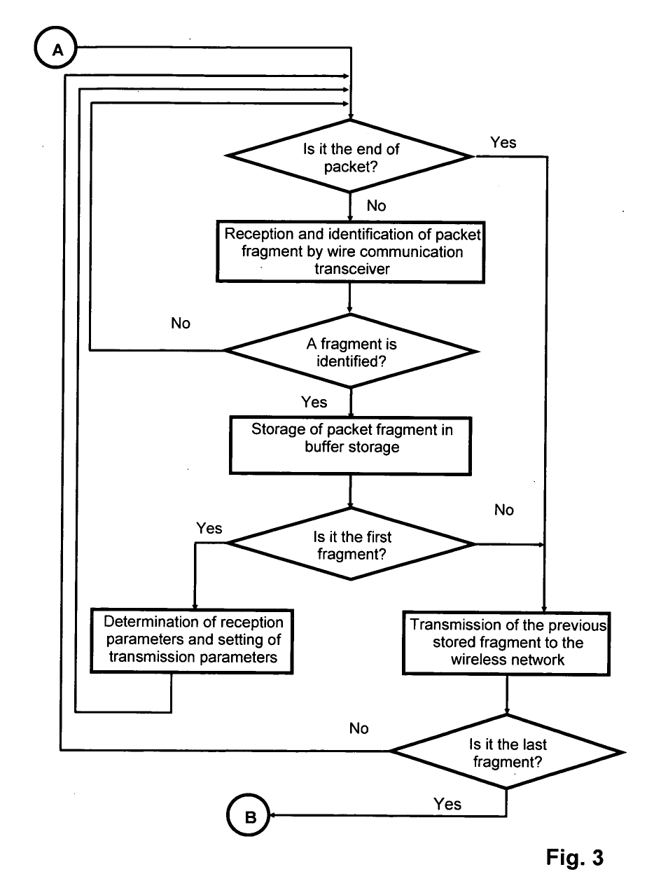

In the case of transmitting the data packet by a wire transceiver, for instance, by transceiver 1₄, to a wireless transceiver of this network, for instance to transceiver 1₂, transceiver 1₄ transmits the data packet via wire line 3 to a network router that has stable radio communication with the addressee, for instance router 2₁. Router 2₁ (see FIG. 4) that is ready to receive signals in wire and wireless communication lines (see FIG. 2, FIG. 3), with the aid of its wire communication transceiver 5 receives an initial fragment of the data packet transmitted by transceiver 1₄, and stores the fragment in buffer storage 9. Processor 8 identifies the fragment, determines the parameters of packet reception, sets the parameters of packet transmission to the addressee—wireless transceiver 1₂. The initial fragment of the data packet, stored in buffer storage 9, is transmitted to wireless transceiver 1₂ with the aid of transceiver 7 of wireless network and antenna system 4₁. Simultaneously with transmission of the initial fragment of the packet, wire communication transceiver 5 receives a successive fragment of the packet, and buffer storage 9 stores it. A cycle of transmission of the fragment of the data packet, stored in buffer storage 9, by router 2₁ and synchronous reception of the successive fragment and the storage of it in buffer storage 9 proceeds right up to the last fragment of the data packet. When transceiver 7 receives this last fragment, router 2₁ is again switched over to reception of signals in wire and wireless communication lines.

### EXAMPLE 3

If one of wireless transceivers transmits a data packet to another wireless transceiver of the hybrid network (see FIG. 1), for instance transceiver 1₂ transmits the data packet to transceiver 1₅, then upon synchronous reception/transmission of fragments of the data packet by router 2₁ in the manner described above, the fragments transmitted by it are received from a wire line by router 2₄ that has stable radio communication with transceiver 1₅. Then router 2₄ performs synchronous reception/transmission of fragments of the data packet in the manner, illustrated by Example 2.

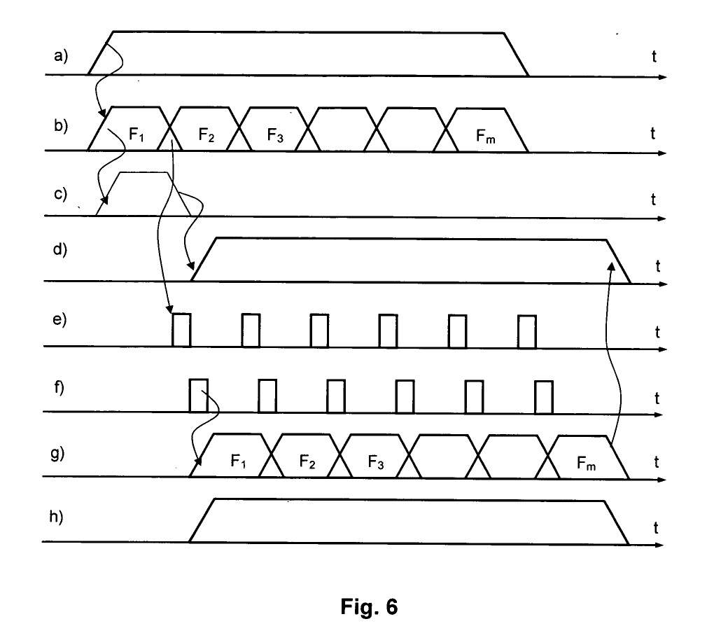

Thus, the routers of the hybrid network claimed herein perform simultaneous signal retransmission with a short delay, required to identify a minimum fragment of the data packet (see FIG. 6), thus providing a maximum rate of data transmission with high signal to noise ratio.

Processor 8 of router, for instance of router 21, receives and identifies a fragment of the data packet being received, determines the parameters of packet reception, sets the parameters of transmission, and transmits the packet to an addressee of the hybrid network (see FIG. 5, FIG. 6) in the following manner. On detecting a signal, for instance via a wireless line, wireless communication transceiver 7 receives an initial fragment of the data packet, device 10 intended for detecting and identifying a fragment of the data packet transforms it into a binary code and enters into buffer storage 9 for a packet fragment. As the fragment is identified, device 11 intended to control and choose reception/transmission mode (with the aid of spectrum choice device 14 of the data packet) determines the parameters of frequency spectrum for transmission of fragments of the data packet, (synchronized with the reception) via a wire line and sets the parameters of frequency synthesizer 15 for wire communication transceiver 5. After buffer storage 9 is filled with a fragment of the data packet, transceiver 5 is switched over to the transmission mode and transmits a fragment coded by coder 13 and read-out from buffer storage 9, simultaneously (synchronously) with the reception of the successive fragment of the data packet (received by transceiver 7), but with a short delay determined by the time needed to fill buffer storage 9.

The process of retransmission of the data packet arrived via a wire communication line is performed by router 21 in a similar manner, the only difference being that the reception of fragments of the data packet is performed by transceiver 5 and transmission of fragments of the data packet is performed by transceiver 7.

Processor 8 may incorporate memory unit 12 intended to store the data that show the structure of the hybrid network. By comparison of the current address contained in the data packet that is received by the router, with addresses stored in unit 12, a decision about retransmission of the packet to the addressee of the network can be made.

When an initial fragment of the data packet is detected, the router can generate a signal of engagement of a communication line, by which the data packet being received will be transmitted.

The routers of the hybrid network can exchange service information, for instance information about addresses of wireless transceivers of the network to ensure further address retransmission of data packets.

The above-listed examples do not restrict other possible options of implementation of the method for data transmission in hybrid networks claimed herein.

Sources of Information
1. U.S. Pat. No. 6,134,587, G06F 15/16, 2000.
2. PCT application No WO 92/11717, H04L 12/46, 1992.
3. USA patent No. 2002/0022467, H04M 9/00, 2002.
4. U.S. Pat. No. 6,243,571, H04Q 7/32, 2001.
5. RF patent No. 2 121 762, H04B 7/26, 1998.
6. U.S. Pat. No. 6,282,405, H04N 7/16, 2001.
7. U.S. Pat. No. 5,901,362, H04B 7/24, 1999.
8. U.S. Pat. No. 6,028,853, H04J 3/06, 2000.
9. U.S. Pat. No. 5,339,316, H04J 3/02, 1994.
10. PCT application No. WO 01/59995, H04L 12/46, 2001.

1. A method for data transmission in a hybrid network that is comprised of at least one wireless transceiver, at least one wire transceiver, and at least one router capable of communicating with the said transceivers of the said network, including:
transmission of a data packet by one of the transceivers of the said network; reception of an initial fragment of the said packet by the router;
storage of the received initial fragment of the said packet in a buffer storage of the router;
transmission of the said fragment, stored in the said storage, by the router to an addressee of the network;
simultaneous reception of a successive fragment of the said packet in the said storage;
repetition of a cycle of transmission of the fragment, stored in the said storage, by the router;
simultaneous reception of a successive fragment and its storage in the storage, right up to the last fragment of the said packet;
transmission of the last fragment of the said packet, stored by the said storage, by the router to the addressee of the said network.

2. The method of claim 1, wherein the identification and storage of a packet fragment (in the identified form) is performed in the course of reception of the said packet fragment in the said storage.

3. The method of claim 2, wherein the parameters of reception of the packet are determined and the parameters of transmission of the data packet to an addressee are set in the course of identification of an initial fragment of the said packet.

4. The method of claim 3, wherein the parameters of spectra of the said packet and the rate of packet reception and transmission are used as the said parameters.

5. The method of claim 1, wherein in the course of transmission of the data packet by one of wireless transceivers of the said network that includes at least two routers and performs reception of an initial fragment of the said packet via a wire line by the second router sent from the first router, storage of the received initial fragment of the said packet in the buffer storage of the second router, transmission of the said fragment, stored in the said storage, by the second router to the wireless transceiver-addressee of the said network, simultaneous reception of a successive fragment of the said packet from the first router and its storage, repetition of a cycle of transmission of the fragment, stored in the said storage, by the second router, simultaneous reception of a successive fragment from the first router and its storage, right up to the last fragment of the said packet, and transmission of the last fragment, stored in the said storage, by the second router to the said addressee of the said network.

6. The method of claim 2, wherein in the course of transmission of the data packet by one of wireless transceivers of the said network that includes at least two routers and performs reception of an initial fragment of the said packet via a wire line by the second router sent from the first router, storage of the received initial fragment of the said packet in the buffer storage of the second router, transmission of the said fragment, stored in the said storage, by the second router to the wireless transceiver-addressee of the said network, simultaneous reception of a successive fragment of the said packet from the first router and its storage, repetition of a cycle of transmission of the fragment, stored in the said storage, by the second router, simultaneous reception of a successive fragment from the first router and its storage, right up to the last fragment of the said packet, and transmission of the last fragment, stored in the said storage, by the second router to the said addressee of the said network.

7. The method of claim 3, wherein in the course of transmission of the data packet by one of wireless transceivers of the said network that includes at least two routers and performs reception of an initial fragment of the said packet via a wire line by the second router sent from the first router, storage of the received initial fragment of the said packet in the buffer storage of the second router, transmission of the said fragment, stored in the said storage, by the second router to the wireless transceiver-addressee of the said network, simultaneous reception of a successive fragment of the said packet from the first router and its storage, repetition of a cycle of transmission of the fragment, stored in the said storage, by the second router, simultaneous reception of a successive fragment from the first router and its storage, right up to the last fragment of the said packet, and transmission of the last fragment, stored in the said storage, by the second router to the said addressee of the said network.

8. The method of claim 4, wherein in the course of transmission of the data packet by one of wireless transceivers of the said network that includes at least two routers and performs reception of an initial fragment of the said packet via a wire line by the second router sent from the first router, storage of the received initial fragment of the said packet in the buffer storage of the second router, transmission of the said fragment, stored in the said storage, by the second router to the wireless transceiver-addressee of the said network, simultaneous reception of a successive fragment of the said packet from the first router and its storage, repetition of a cycle of transmission of the fragment, stored in the said storage, by the second router, simultaneous reception of a successive fragment from the first router and its storage, right up to the last fragment of the said packet, and transmission of the last fragment, stored in the said storage, by the second router to the said addressee of the said network.

9. A router of the hybrid network that includes a wire communication transceiver with a matching device intended for connection to the wire line, a wireless communication transceiver with an antenna system, a processor designed for processing data packets to transmit and receive them via radio channel and wire line, and a buffer storage intended to store a fragment of the said packet, wherein the first input/output of the wire communication transceiver is intended for connecting to the wire line through the matching device, whereas its other inputs/outputs are connected to the inputs/outputs of the said processor; the first input/output of the wireless communication transceiver is connected to the antenna system, whereas its other inputs/outputs are connected to the inputs/outputs of the said processor, connected to the said buffer storage.

10. The router of claim 9, wherein the said processor incorporates a device intended for detecting and identifying a fragment of the data packet, a device intended for controlling and choosing reception/transmission mode, with said device being equipped with a unit for storing the structure of the said network, a coder intended to code the fragment of the said packet being transmitted, a device intended for choosing a spectrum for data packet, a frequency synthesizer and a synthesizer of reception/transmission of the data packet, wherein, the first and the second inputs of the device, intended for detecting and identifying a fragment of the data packet, are connected to the second output of the wire communication transceiver and the second output of the wireless communication transceiver, respectively;
the first output of the device, intended for detecting and identifying a fragment of the said packet, is connected to the first input of the said buffer storage, whereas its second output is connected to the first input of the device for controlling and choosing the reception/transmission mode, whose first output is connected to the second input of the wire communication transceiver;
the second output is connected to the second input of the wireless communication transceiver;
the third output is connected to the input of the spectrum choice device for the data packet;
the fourth output is connected to the input of the reception/transmission synthesizer;
the fifth input/output is connected to the memory unit of the network structure;
the sixth output is connected to the first input of the coder intended for coding a fragment of the data packet;
the seventh output is connected to the second input of the said buffer storage, whose output is connected to the second input of the coder intended for coding the said fragment;
the first and the second outputs of the coder are connected to the third input of the wireless communication transceiver and to the third input of the wire communication transceiver, respectively, whose fourth inputs are connected to the first and the second outputs of the frequency synthesizer, respectively, the frequency synthesizer's input is connected to the output of the spectrum choice device for the data packet;
the first and the second outputs of the reception/transmission synthesizer are connected to the fifth inputs of the wireless communication transceiver and of the wire communication transceiver, respectively.

11. The router of claim 9, wherein the said antenna system includes an antenna with a directional or controlled pattern.
